(19) United States
(12) Patent Application Publication
(10) Pub. No.: US 2012/0325877 A1
(43) Pub. Date: Dec. 27, 2012

(54) TAILGATE TOOLCHEST

(76) Inventor: Kevin Douglas FRANKS, Morton, TX (US)

(21) Appl. No.: 13/533,010

(22) Filed: Jun. 26, 2012

Related U.S. Application Data
(60) Provisional application No. 61/501,343, filed on Jun. 27, 2011.

(51) Int. Cl. B60R 11/06

(52) U.S. Cl. 224/404

(57) ABSTRACT

A low profile toolchest for storing tools in a pickup, the toolchest having a rectangular frame, the frame having a length and width substantially that of the interior side of a pickup tailgate and mounted thereto, having a depth of fewer than five inches and having adhered to its bottom side a floor, the floor being padded on its interior side, the frame further having at least two center supports dividing the frame into at least two separate cavity compartments, each compartment further having hinged along the inside of its superior end a door, the door further having a closure latch.

### CROSS REFERENCE TO RELATED APPLICATIONS

This application claims the benefit of provisional patent application 61/501,343 filed on Jun. 27, 2011 by the present inventor and the application is hereby incorporated by reference in its entirety.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING

Not Applicable

### DESCRIPTION OF ATTACHED APPENDIX

Not Applicable

### BACKGROUND OF THE DISCLOSED TECHNOLOGY

1. Field Of The Invention

The disclosed relates generally to toolchests and specifically to toolchests for mounting onto vehicle tailgates.

2. Description of Related Art

A storage area to carry tools in is a necessity for many drivers of pickup trucks or other vehicles having a rear bed space and rear bed tailgate. A wide variety of toolchests exist on the market, such as the well known diamond plated type that traditionally mount in the front of the pickup truck bed, near the cab. There are numerous disadvantages associated with the traditional front bed mount toolchest. The first disadvantage is that the toolchest is inconvenient to retrieve tools from due to its location. The user must either climb in the bed of the truck and walk to the front of the bed to retrieve the tool or, if they are tall enough, attempt to reach into the toolchest from the side of the truck. The second disadvantage is that the traditional truck bed toolchest is merely a box with a latching lid. As a result, tools tend to gather themselves into a jumbled heap in the bottom of the deep box, such that the user has to dig and search for the desired tool. The third disadvantage is that the toolchest is readily visible to passersby, thus encouraging the possibility of theft of tools. A fourth disadvantage is that the traditional toolchest projects into the bed of the truck significantly, taking up a large amount of bed space. Yet another disadvantage is that the traditional truck toolchest has no workspace convenient to its placement.

There is a need for a toolchest specifically designed for pick-up truck use, having features of convenience, tool organization, low visibility by casual passersby, low bed space consumption and ease of use. The device should be easy to mount, capable of reasonably easy removal, durable and reasonably light weight enough to serve its intended purpose.

### SUMMARY OF THE INVENTION

In accordance with the present invention, a device is disclosed for organizing and storing tools in a pickup truck bed, namely on the tailgate.

An objective of the disclosure is a device for storing and organizing tools in a pickup truck bed, in such a way that the tools are conveniently located at the tailgate end of the truck.

An objective of the disclosure is a device for storing and organizing tools in a pickup truck bed, the device being hidden from view to a casual passerby when the tailgate is in the closed position.

An objective of the disclosure is a device for storing and organizing tools in a pickup truck bed, the device providing a workspace in addition to the tool storage function.

An objective of the disclosure is a device for storing and organizing tools in a pickup truck bed, the device having the capability of the tools standing up vertically when the chest is open, for ease of access by the user.

An objective of the disclosure is a device for storing and organizing tools in a pickup truck bed, wherein each tool can be held securely in its separate space and does not rattle around against the other tools or against the floor of the toolchest.

An objective of the disclosure is a device for storing and organizing tools in a pickup truck bed, the device having a low profile to avoid encroaching onto storage space in the pickup truck bed.

An objective of the disclosure is a low profile toolchest for storing tools in a pickup, the toolchest comprising: a rectangular frame, the frame having a length and width substantially that of the interior side of a pickup tailgate and mounted thereto, having a depth of fewer than five inches and having adhered to its bottom side a floor, the floor being padded on its interior side, the frame further having at least two center supports dividing the frame into at least two cavity separate compartments, the compartments having a depth the same as the frame, each compartment further having hinged along the inside of its superior end a door, the door further having a closure latch.

A low profile toolchest for storing tools in a pickup, the toolchest comprising: a rectangular frame, the frame having a length and width substantially that of the interior side of a pickup tailgate and mounted thereto, having a depth of fewer than five inches and having adhered to the bottom of the frame a floor, the floor being padded on its interior side and lying parallel to and flush on top of the inside of the tailgate, the frame further having at least two center supports dividing the frame into at least two separate cavity compartments, each compartment further having hinged along the inside of its superior end a door, the door further having a closure latch and concealing, when in the closed position, the cavity compartment and further creating a workspace.

Other advantages of the present invention will become apparent from the following descriptions, taken in connection with the accompanying figures, wherein, by way of illustration and example, an embodiment of the present invention is disclosed.

### BRIEF DESCRIPTION OF THE DRAWINGS

The figures constitute a part of this specification and include exemplary embodiments to the invention, which may be embodied in various forms. It is to be understood that in some instances various aspects of the invention may be shown exaggerated or enlarged to facilitate an understanding of the invention. To enable more thorough understanding of the features and advantages of the present invention, reference is now made to the detailed description of the invention along with the accompanying figures in which:

FIG. 1 is an inside view of the pickup bed showing the closed toolchest mounted on the closed tailgate.

FIG. 2 is a perspective view of the interior of the pickup bed with the tailgate open and the closed toolchest mounted in place on the tailgate.

FIG. 3 is a perspective view of the toolchest in the open position on the open tailgate.

FIG. 4 is a phantom view of the side profile of the toolchest on the closed tailgate.

FIG. 5 is a perspective view of the mounting holes in the tailgate.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

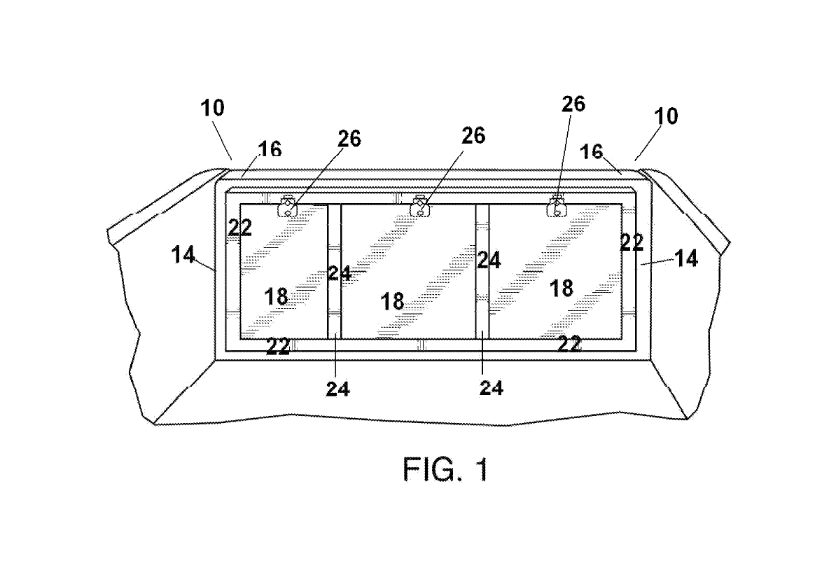

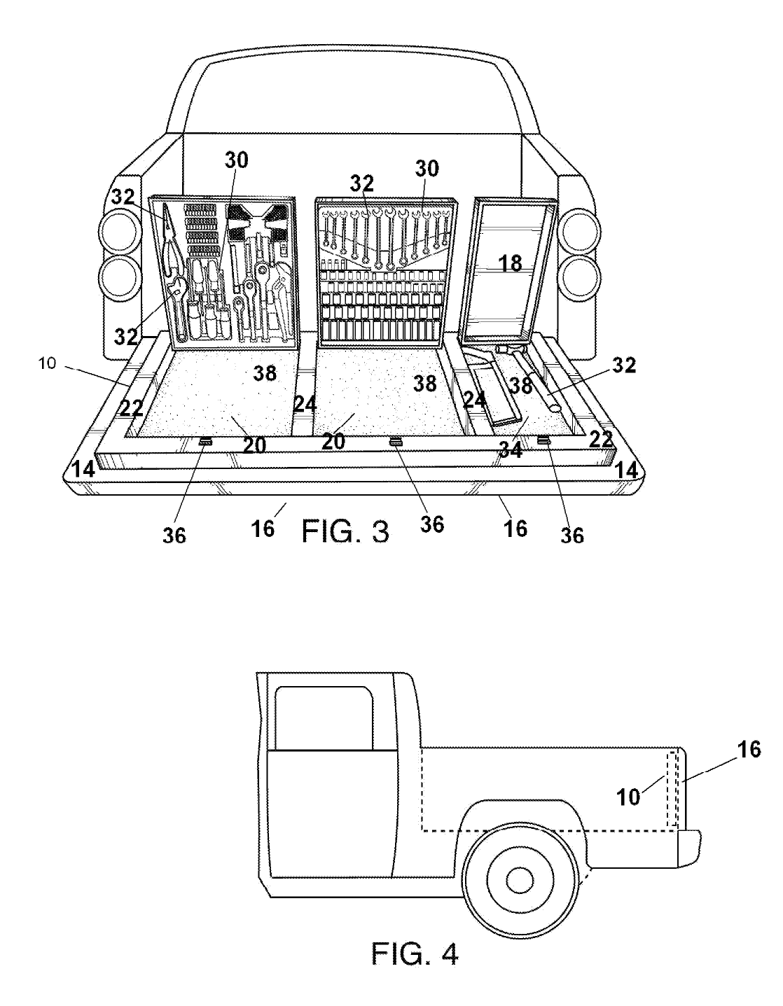

Turning to the illustrations, as exhibited in FIG. 1, in a preferred embodiment, the disclosed toolchest 10 is pictured in the closed position, mounted to the interior side 14 of the tailgate 16, which, in FIG. 1 is also in the closed position. The toolchest 10 has a thin profile and, in the preferred embodiment, shows three separate doors 18 each serving as the cover for each of three separate cavity compartments 20 (shown in FIG. 3). The toolchest 10 cavity compartments 20 are created by a frame 22 which, in the preferred embodiment is constructed of tubular aluminum. The frame 22 has a length and width substantially similar to, but slightly smaller than, that of a standard pickup tailgate. The frame has a height (depth) of, in the preferred embodiment, two and one/half inches although a range of depths is possible provided a depth is used that accommodates at least a single layer of tools but yet keeps the toolchest slim and low profile against the tailgate. The frame should be less than five inches in height (depth) and preferably less than four inches.

The frame has at least one center support 24 for increased strength and durability and for dividing the interior of the frame 22 into the separate cavity compartments 20. Each compartment 20 is covered by a door 18, further having a latch 26 for secure closure, especially during travel. The latch may be a compression or a draw latch or latch of another type meeting the objectives described herein. In a preferred embodiment, the latch is a quick release draw latch.

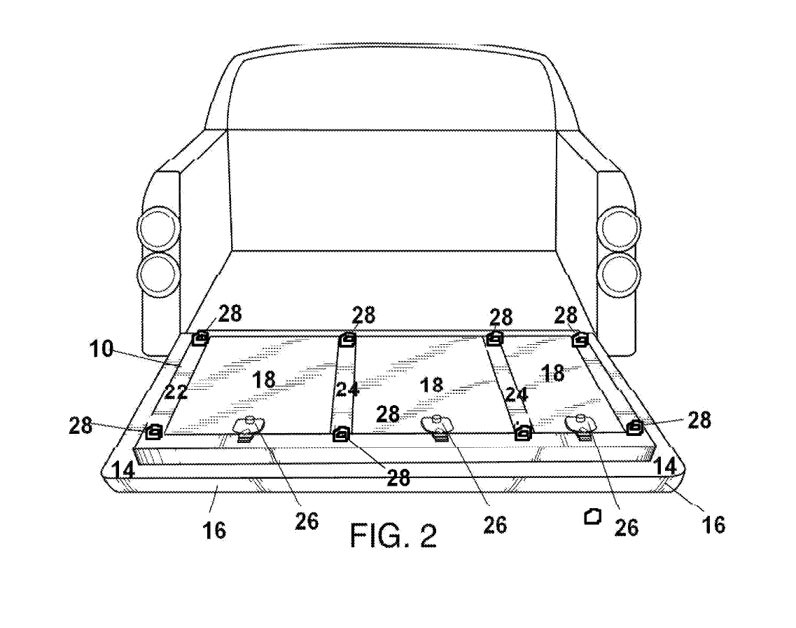

Turning to FIG. 2, the closed toolchest 10 is pictured in a perspective view, mounted on the interior side 14 of the tailgate 16, which, in FIG. 2, is pictured in the open position. The frame 22 is more easily visualized in FIG. 2 and the top of the doors 18, in their pictured closed positions lie flush with the top side of the frame 22 and conceal the cavity compartments 20. A separate latch 26 for each of the three separate doors 18 is pictured. The bolts 28 used in mounting the frame 22 of the toolchest 10 to the interior side 14 of the tailgate 16 are visible.

FIG. 3 shows in more detail some of the novel advantages to the disclosed toolchest 10. Use of the framed in box type construction enables more functionality and versatility, in that at least some of the doors house recesses 30 for holding each separate tool 32. The recesses 30 may be made of injection molded plastic, foam, or other suitable materials that will retain the tool 32 in its corresponding shape. When the door 18 is in the closed position, the door 18, housing the tools 32, fits neatly down into the cavity compartments 20 of the frame 22, with the top of the door 18 sitting flush and level to the top of the frame 22. In the disclosed embodiment, two of the doors for the cavity compartments 20 are shown having the tools 32 in the fitted recesses 30, while a third compartment 20 door 18 is empty, serving as a top and cover for the third cavity compartment, this compartment being usable for storage of miscellaneous or odd fitting tools 32 that can be freely placed in the compartment. In the figure, the interior of the door for the third compartment 34 is shown as open space to cover the miscellaneous or odd fitting tools that can lie freely in the compartment. Shown on the frame 22 is the receiving end 36 of the latch 26 shown on FIG. 2. Visible in FIG. 3 is the floor 38 of the toolchest, the floor 38 being adhered to the bottom of the frame 22 prior to the frame being mounted to the tailgate 16. The floor 38 is substantially the length and width of the frame. The floor 38 is padded, such that the tools 32 rest against it without making noise or being damaged during travel.

FIG. 4 illustrates a phantom view of the slim profile of the toolchest 10 mounted on the interior side 14 of the tailgate 16 in the closed position.

When the tailgate is in the open position and the toolchest is in the closed position as shown in FIG. 2, a workspace is created on which to use the housed tools. In an embodiment, gas or hydraulic shocks may be included on the doors for more controlled opening and closing. An important advantage to the disclosed toolchest is that rather than having as a bottom a flat sheet of metal, or the inside of the tailgate itself, the disclosed toolchest 10 incorporates a raised frame 22 having its own padded floor 38 which is adhered to the bottom of the frame 22 and lies parallel to and on top of the interior side 14 of the tailgate 16. This enables the toolchest to be removed from the tailgate altogether, and used on other vehicles or for other purposes. It also enables the tools to rest against a cushioned or padded surface rather than laying on the tailgate itself. The tools are thereby protected and do not scratch the tailgate, nor do they make noise from rattling around. The raised frame concept further enables the door of each compartment to fit down inside the frame when the door is closed, such that the top side of the door is flush to the top side of the frame, creating a flat work surface when the doors are closed.

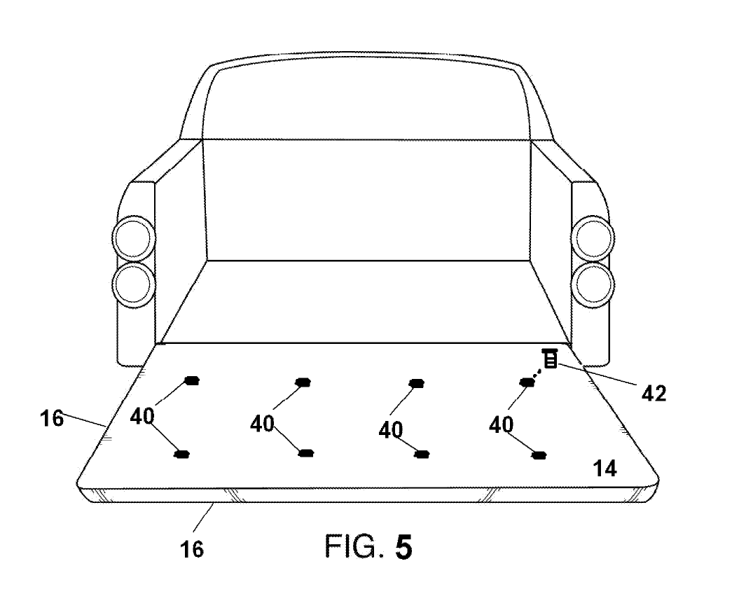

The toolchest is mounted onto the interior side of the tailgate in the following fashion. In a preferred embodiment, the toolchest is positioned on the open tailgate and holes are drilled through the frame of the toolchest and into the tailgate of the truck, eight being preferred and equally spaced apart, although other numbers may be possible. FIG. 5 demonstrates the holes 40 on the interior side 14 of the tailgate 16. The toolchest 10 is removed and into each hole 40 is set a rivet nut 42 for receiving a bolt 28. The toolchest 10 is positioned back onto the tailgate 16 and into each hole 40 is placed a bolt 28, as shown in FIG. 2, preferably a ¼′×3″ bolt, which traverses through the holes 40 on the toolchest 16 and into the rivet nut 42 that is positioned into the holes 40 of the tailgate 16. Upon tightening of the bolt 28, the toolchest is secured tightly against the interior side 14 of the tailgate 16. A washer is preferably used with the bolt 28.

In the preferred embodiment, the toolchest is 48″ long, 20.5″ wide and a height (depth) of 2.5″. These dimensions allow for the toolchest to fit well on a standard size pickup tailgate, accommodate the tools well and yet cause the toolchest to be slim enough in profile that it is not easily seen when the tailgate is closed. The toolchest may not be wider or longer than the tailgate. A unique feature of the disclosed is that it is manufactured with the tool recesses built in, and sold with the tools already in place. Rather than selling just a housing, chest or box for tool storage, the disclosed is sold as a complete toolchest, preloaded with specific tools that fit into custom made recesses already manufactured into the design.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It is to be understood that the embodiments disclosed herein are shown for illustrative purposes and are not intended to be construed as limitations of the disclosed method and system. Those skilled in the art will recognize or be able to ascertain in the course of routine experimentation, that variations and equivalents of the embodiments may be undertaken without departing from the scope of the invention.

Certain terms are used throughout the description to refer to particular method components. As one skilled in the art will appreciate, design and manufacturing companies may refer to a component by different names. This document does not intend to distinguish between components that differ in name but not function.

The terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other intermediate devices and connections. Moreover, the term “method” means “one or more components” combined together. Thus, a method can comprise an “entire method” or “sub methods” within the method.

The use of the word “a” or “an” when used in conjunction with the word “comprising” may mean “one”, or may also mean “one or more.” The use of the term “or” in the claims is used to mean “and/or” unless explicitly indicated to refer to alternatives only or the alternatives are mutually exclusive, although the disclosures supports a definition that refers to only alternatives and “and/or.”

The word “toolbox” is used interchangeably herein with the word “toolchest.”

The methods and systems disclosed and claimed herein can be made and executed without undue experimentation based on the level of disclosure presented. While the methods and systems have been described in terms of their preferred embodiments, it will be apparent to those skilled in the art that they are not limited to the exact steps described and may vary from such description without departing from the scope and spirit of the invention. The substitutes and modifications employed by one skilled in the art are deemed to fall within the scope of the invention.

What is claimed is:

1. A low profile toolchest for storing tools in a pickup, the toolchest comprising:
a rectangular frame, the frame having a length and width substantially that of the interior side of a pickup tailgate and mounted thereto, having a depth of fewer than five inches and having adhered to the bottom of the frame a floor, the floor being padded on its interior side, the frame further having at least two center supports dividing the frame into at least two separate cavity compartments, each compartment further having hinged along the inside of its superior end a door, the door further having a closure latch.

2. The toolchest of claim 1 wherein at least one door further has, on its interior side, individual recesses shaped to accommodate individual tools.

3. The toolchest of claim 1 wherein at least one compartment accommodates the placement of loose tools, the door closing over the top of the tools.

4. The toolchest of claim 1 wherein the compartment doors further have hydraulic shocks.

5. The toolchest of claim 1 further having three separate cavity compartments.

6. The toolchest of claim 1 further having a depth of fewer than four inches.

7. The toolchest of claim 1 further having a depth between two and a half and three inches.

8. The toolchest of claim 1 wherein the frame is further comprised essentially of tubular aluminum.

9. The toolchest of claim 1 wherein the top side of the doors, when closed, lie flush with the top of the frame, creating a flat workspace.

10. The toolchest of claim 1 wherein the closure latch is a draw latch.

11. The toolchest of claim 1 wherein the closure latch is a quick release latch.

12. A low profile toolchest for storing tools in a pickup, the toolchest comprising:
a rectangular frame, the frame having a length and width substantially that of the interior side of a pickup tailgate and mounted thereto, having a depth of fewer than five inches and having adhered to the bottom of the frame a floor, the floor being padded on its interior side and lying parallel to and flush on top of the inside of the tailgate, the frame further having at least two center supports dividing the frame into at least two separate cavity compartments, each compartment further having hinged along the inside of its superior end a door, the door further having a closure latch and concealing, when in the closed position, the cavity compartment and further creating a workspace.

13. The toolchest of claim 12 wherein at least one door further has, on its interior side, individual recesses shaped to accommodate individual tools.

14. The toolchest of claim 12 wherein at least one compartment accommodates the placement of loose tools, the door closing over the top of the tools.

15. The toolchest of claim 12 wherein the compartment doors further have hydraulic shocks.

16. The toolchest of claim 12 further having three separate cavity compartments.

17. The toolchest of claim 12 further having a depth of fewer than four inches.

18. The toolchest of claim 12 further having a depth between two and a half and three inches.

19. The toolchest of claim 12 wherein the frame is further comprised essentially of tubular aluminum.

20. The toolchest of claim 12 wherein the closure latch is a draw latch.
